(19) United States
(12) Patent Application Publication
(10) Pub. No.: US 2006/0218788 A1
(43) Pub. Date: Oct. 5, 2006

(54) Method of manufacturing a hollow blade that includes a recessed tip cap and method of reparing such a blade

(75) Inventors: Michel Boulnois, Lieusaint (FR); Claude Pagnon, Vaux Sur Mer (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SNECMA SERVICES, Paris (FR)

(21) Appl. No.: 11/429,945

(22) Filed: May 9, 2006

(30) Foreign Application Priority Data
Mar. 30, 2005 (FR) 05 50811

(51) Int. Cl. B21K 3/04; B23P 15/02

(52) U.S. Cl. 29/889.72; 29/889.7

(57) ABSTRACT

The invention relates to a method of manufacturing a hollow metal blade, comprising at least one side wall and a recessed tip cap, characterized in that: a) a hollow blade, which comprises at least one side wall and the tip of which is open, is manufactured by casting; b) a plate of a laminate, comprising at least the metal of the blade and a brazing material, is manufactured; c) the plate is brazed to the top of the side wall of the blade by pressing the plate onto the blade; and d) the recessed tip cap, comprising at least a bottom and at least a squealer tip, is machined in the plate. Thanks to the invention, since the blade is manufactured beforehand with an open tip, the core can be held in place, during the casting operation, by the top, thereby ensuring great precision in the positioning of the core and therefore in the thickness of the walls of the blade. The invention also relates to a method of repairing a blade.

The invention relates to a method of manufacturing a hollow blade that includes a recessed tip cap, to a method of repairing such a blade and to a blade obtained by one of these methods.

Some blades of a turbojet are hollow and include a recessed tip cap, that is to say one in which the walls form a cup-shaped recess having a bottom. These blades are manufactured by casting. In one known embodiment, a core is suspended in a mould by two platinum wires and the metal is poured into the mould around the core, forming the walls of the blade and a recessed tip cap. The core is then removed, for example by dissolving it.

Because the core is suspended by the platinum wires, the bottom of the recessed tip cap includes holes, which have to be plugged, for example by brazing frustoconical plugs therein, thereby complicating the manufacturing method. In addition, this brazing may not be perfect and may induce imperfections in the recessed tip cap. In the event of a problem during brazing, it is sometimes necessary to carry out several brazing cycles—these are performed at 1200° C. and cause the growth of what are called “gamma prime” crystalline phases in the alloy forming the blade, thereby reducing its lifetime. Moreover, since the core is suspended by the wires, its position is not under perfect control and the side walls of the blade and the bottom of the recessed tip cap run the risk of not being formed with the required thickness. It is therefore necessary to tolerate significant manufacturing clearances.

The object of the present invention is to alleviate these drawbacks.

For this purpose, the invention relates to a method of manufacturing a hollow metal blade, comprising at least one side wall and a recessed tip cap, characterized in that:

a) a hollow blade, which comprises at least one side wall and the tip of which is open, is manufactured by casting;

b) a plate of a laminate, comprising at least the metal of the blade and a brazing material, is manufactured;

c) the plate is brazed to the top of the side wall of the blade by pressing the plate onto the blade; and

d) the recessed tip cap, comprising at least a bottom and at least a squealer tip, is machined in the plate.

Thanks to the invention, since the blade is manufactured beforehand with an open tip, the core can be held in place, during this casting operation, by the top, using means chosen with all the freedom that this opening provides. This ensures great precision in the positioning of the core and therefore in the thickness of the walls of the blade. Since the bottom of the recessed tip cap does not include a brazed plug, the blade does not undergo brazing operations, thereby avoiding all the drawbacks associated therewith and increasing the lifetime of the blade.

Another advantage of the invention can be noted. The walls of the blades generally include cooling holes, produced by laser drilling once the walls of the blades have been formed. The operation of protecting the blade during this drilling was complicated to implement in the case of the blades of the prior art, in so far as the inside of the blade was not readily accessible owing to the presence of the recessed tip cap formed during the casting operation. Thanks to the invention, it is possible to perform this drilling operation before the laminate plate is brazed, the inside of the blade then being readily accessible so as, for example, to place a protective plate therein. The inside of the blade is also available for carrying out a machining or cleaning operation on its internal walls.

Advantageously, the top of the wall of the blade is ground before step c).

Thus, since the top of the walls has been machined, the brazing of the laminate to this top takes place at a perfectly defined height. This allows the position of the internal surface of the bottom of the recessed tip cap to be precisely adjusted, the external surface of the recessed tip cap then being machined in a conventional and well-controlled manner.

The method described above is very suitable for carrying out a repair, and thus the invention also relates to a method of repairing the tip of a hollow metal blade, having at least one side wall and a recessed tip cap, which comprises at least a bottom and at least a squealer tip, characterized in that it comprises the steps of the manufacturing method described above, in which step a) is replaced by the following step:

a′) the tip of the blade is cut on a level with the bottom of its recessed tip cap so as to obtain a blade having at least one side wall, the tip of the blade being open.

Finally, the invention relates to a hollow metal blade having at least one side wall and a recessed tip cap, which has at least a bottom and at least a squealer tip, said blade being obtained by one of the methods described above.

The invention will be more clearly understood from the following description of the preferred way of implementing the methods and the preferred embodiment of the blade of the invention, with reference to the appended drawings in which:

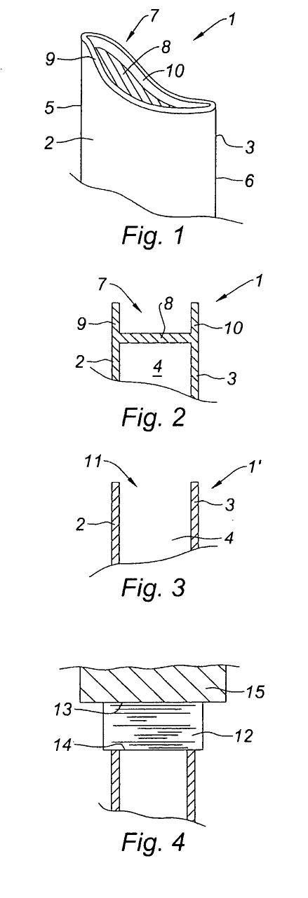

FIG. 1 shows a schematic perspective view of a hollow blade obtained by the method of manufacturing a blade of the invention;

FIG. 2 shows a sectional view of the blade of FIG. 1;

FIG. 3 shows a schematic sectional view of an open blade tip after step a) of the manufacturing method of the invention; and

FIG. 4 shows a schematic sectional view of a blade in step c) of the manufacturing method of the invention.

The aim of the blade manufacturing method of the invention is, as shown in FIGS. 1 and 2, to manufacture a blade 1, in this case a moving blade 1 of a turbojet. The terms “internal” and “external” are understood to mean internal and external relative to the axis of the turbojet in which the blade is intended to be mounted radially. The blade 1 is a hollow blade, comprising, on the internal side, a root portion (not shown) from which the two side walls 2, 3, called the pressure face and the suction face respectively, extend, a cavity 4 being defined between said side walls. The cavity 4 is used for cooling the blade 1 and may include elements, for example cooling fins or studs, that participate in this function. The blade 1 here is shown with two walls 2, 3, but it may include partitions that define a plurality of cavities therebetween.

The blade 1 has, on its external side, a recessed tip cap 7. This recessed tip cap 7 has a bottom wall 8 extending transversely between the side walls 2, 3 and completely or partly filling the opening between the two. Extending from the bottom wall 8 are two walls forming squealer tips 9, 10 which, in the same manner as previously, join up with the leading edge 5 and trailing edge 6 of the blade 1. These squealer tips 9, 10 lie here along the extension of the side walls 2, 3 of the blade 1 and have the same thickness as them.

The method of the invention for manufacturing the blade 1 will now be described.

The first step, as shown in FIG. 3, is to manufacture a hollow blade 1′, comprising a root portion (not shown) from which two side walls 2, 3 extend, and the tip 11 of which is open. In other words, the side walls 2, 3 form a cavity 4 which is open at their external end. The blade 1′ is manufactured by casting. The metal is poured into a mould in which a ceramic core is held suspended, the metal being inserted between the core and the walls of the mould in order to form the walls 2, 3 of the blade 1′. Since the tip 11 of the blade 1′ is open, it is easy to keep the core in place by rigid, and possibly bulky, mechanical means via this opening, so as to ensure that the core is always kept in the correct position relative to the mould throughout the process. The precision is greater than in the prior art, in which the core is suspended by wires and there is a risk of floating. In addition, the core can be easily removed at the end of the casting process, via the open side of the blade 1′.

The invention applies particularly to a blade 1′ made of a nickel-based alloy called AM1. This alloy has the following composition by weight: 6.0 to 7.0% Co; 7.0 to 8.0% Cr; 1.8 to 2.2% Mo; 5.0 to 6.0% W; 7.5 to 8.5% Ta; 5.1 to 5.5% Al; 1.0 to 1.4% Ti; Nb, Mn and Si each less than 0.05%; C, B, Cu, P, S, Mg, Sn and Zr each less than 0.01%; Hf and Fe each less than 0.2%; and Ni the balance up to 100%.

A blade 1′ is obtained which therefore has a root portion, on the internal side, and two side walls extending towards its tip 11, on the external side, which is open.

It is possible to form cooling holes on the walls 2, 3 in order to discharge the cooling air. These holes are generally obtained by laser drilling. Since the tip 11 of the blade 1′ is open, it is easy to place protective plates inside the blade 1 so as to stop the laser beam that has passed through a wall 2, 3 of the blade 1′.

It is also possible to machine or clean the inside of the open blade 1′.

The side walls 2, 3 of the blade are then ground by machining, that is to say they are cut and polished so as to make them stand up to the desired height, in this case the height to which it is desired that the internal wall extends from the bottom 8 of the recessed tip cap 7. As this grinding is carried out by machining, it is very precise. This grinding is unnecessary in the case in which the casting process would permit to form the walls 2, 3 very precisely.

Referring to FIG. 4, a plate 12, of laminate material, is moreover manufactured. Such a plate 12 comprises various layers of materials mixed together, the relative concentrations of the base materials of which vary through the thickness of the plate 12. In the particular case considered, the plate comprises AM1 alloy and a brazing material, for example one based on nickel, chromium or boron. A first face 13 of the plate has an AM1 concentration of 100% while the opposite face 14 has a concentration of brazing material equal to 100%. Between these two faces 13, 14, the concentrations decrease and increase, respectively, in order to represent, for each material, 100% on one side and 0% on the other. These extreme concentrations need not be equal to 100% and 0%, but overall the plate 12 has one face with a high concentration of one material and the other face with a high concentration of the other material, the concentrations varying in a linear or non-linear manner between the two faces. Typically, the plate 12 is manufactured by powder spraying onto a steel support, the AM1 and brazing material concentration of the powder progressively changing with the thickness formed. These laminates are well known to those skilled in the art and their manufacture will not be explained in detail below. The laminate 12 may be manufactured before, during or after manufacture of the open blade 1′, its manufacture taking place independently.

The laminate plate 12 has a thickness at least equal to the height of the bottom 8 and the squealer tips 9, 10 of the recessed tip cap 7 of the blade 1 that it is desired to manufacture. The dimensions of its cross section, transverse to the direction of its thickness, are slightly greater than the cross section of the open blade 1′ on a level with its tip 11, and therefore correspond to the shape and to the dimensions of the recessed tip cap 7, but slightly increased. The plate 12 is preferably cut by water jets, in a manner well known to those skilled in the art, so as to avoid the creation of disturbed regions in the plate 12.

The next step in the manufacture of the blade 1, namely the brazing of the plate 12 to the open blade 1′, is then carried out. For this purpose, the plate 12 is brought into contact, via its face 14 containing a 100% concentration of braze, on the tip 11 of the open blade 1′. A ram 15 is applied on the other face 13, the blade 1′ being held in place at its internal end, for example on a press bed. The whole assembly is contained in a furnace, here at 1100° C., in a vacuum or in an inert atmosphere. The choice of this temperature depends on the material of the blade 1′. In the present case, the alloy AM1 has a good internal structure at 1100° C., but this structure degrades very appreciably above 1200° C., hence the choice of the temperature, guided by the wish not to impair the lifetime of the blade 1. Pressure is applied this way to the plate 12 for four hours. This results in the plate 12 being “self-brazed” to the walls 2, 3 of the blade 1′, the brazing material contained in the plate 12 being brazed to the top of the walls 2, 3. Specifically, due to the temperature and pressure, intermetallic diffusion takes place between the plate 12 and the walls 2, 3 of the blade 1′, which diffusion is accelerated by the pressure, resulting in the elements being brazed together. The pressure applied here is 15 bar. In the particular case considered, graphite stops are provided alongside the plate 12, at a height corresponding to the desired height of the recessed tip cap 7, so as to prevent the plate and/or the blade 1′ from being crushed due to the high pressure.

Once the plate 12 has been brazed to the blade 1′, the recessed tip cap 7 is machined in the plate 12—the recessed tip cap 7 is said to be “knocked out”. For this purpose, the plate 12 is subjected, via its external side, that is to say via the same side as the face 13 containing 100% AM1, to an electrical discharge machining operation so as to hollow out the recessed tip cap 7. This machining is carried out until the external surface of the bottom wall 8 of the recessed tip cap 7 is at the correct height and the surfaces, located on the inside of the blade 1, of the squealer tips 9, 10 of the recessed tip cap 7 are suitably formed. Such electrical discharge machining is perfectly well controlled and allows the recessed tip cap 7 to be machined very precisely. The internal surface of the bottom wall 8 itself is already at the correct height, since it was brazed to the top of the side walls 2, 3 of the open blade 1′, said walls being ground to the desired height, taking into account any deformation that may occur during the brazing.

Next, the surfaces of the squealer tips 9, 10, located on the external side of the blade 1, are machined so as to give them the desired thickness, in this case so that the external surfaces of the squealer tips 9, 10 lie in the extension of the external surfaces of the side walls 2, 3.

It is possible to drill cooling holes in the bottom 8 of the recessed tip cap 7 in the same manner as in the prior art.

Finally, the top of the squealer tips 9, 10 is machined so that the squealer tips are at the correct height. The blade 1 shown in FIGS. 1 and 2 is thus obtained.

Since this blade 1 has not been subjected to brazing operations at 1200° C. as in the prior art, its lifetime is increased. The thickness of the various walls 2, 3, 8, 9 and 10 is also under complete control.

The method that has just been described may be suitable for repairing the tip of a blade 1. In such a repair method, in which it is desired to reshape a damaged blade tip for example, the tip of the blade 1 is cut so as to obtain an open blade 1′ similar to that in FIG. 3, the height of the top of the walls 2, 3 being adapted to the position that it is desired to give the bottom 8 of the recessed tip cap 7. Starting from this open blade 1′, the method of manufacturing the recessed tip cap 7 is then strictly identical to that which has just been described.

Another advantage of the invention may be noted. When brazing the plate 12 to the open blade 1′, it is possible that a bead appears in the region that has been brazed. Such a bead, located on the inside of the blade, does not affect its operation and can therefore be left as such. A bead located on the outside of the blade can be machined off afterwards, when the external surfaces of the squealer tips of the recessed tip cap are being machined. However, before this bead is machined off, it has the advantage of being an indicator that brazing has indeed taken place.

The laminate plate that has been presented comprises only AM1 and brazing material. The advantage of using a laminate is the great freedom that it grants in the choice of materials. It is therefore possible to add materials, making it possible to give the recessed tip cap additional characteristics. For example, it is possible, on the external side, to provide a coating material in order to prevent rubbing wear of the blade on its retaining casing, if there is one.

1- Method of manufacturing a hollow metal blade, comprising at least one side wall and a recessed tip cap, characterized in that:
a) a hollow blade, which comprises at least one side wall and the tip of which is open, is manufactured by casting;
b) a plate of a laminate, comprising at least the metal of the blade and a brazing material, is manufactured;
c) the plate is brazed to the top of the side wall of the blade by pressing the plate onto the blade; and
d) the recessed tip cap, comprising at least a bottom and at least a squealer tip, is machined in the plate.

2- Method according to claim 1, in which the top of the wall of the blade is ground before step c).

3- Method according to claim 1, in which the outer surface of the squealer tip is machined after step d).

4- Method according to claim 1, in which the top of the squealer tip is machined after step d).

5- Method according to claim 1, in which step d) is carried out by electrical discharge machining.

6- Method according to claim 1, in which the blade is made of a nickel alloy.

7- Method of repairing the tip of a hollow metal blade, having at least one side wall and a recessed tip cap, which comprises at least a bottom and at least a squealer tip, characterized in that it comprises the steps of the manufacturing method of claim 1, in which step a) is replaced by the following step:
a′) the tip of the blade is cut on a level with the bottom of its recessed tip cap so as to obtain a blade having at least one side wall, the tip of the blade being open.
